(19) United States
(12) Patent Application Publication
(10) Pub. No.: US 2004/0224059 A1
(43) Pub. Date: Nov. 11, 2004

(54) Microwave food heating paper towels

(76) Inventor: John Solomon Esparza, Collinsville, IL (US)

Correspondence Address: John Solomon Esparza, 1517 Eleanor Dr., Swansea, IL, 62226, US

(21) Appl. No.: 10/347,479

(22) Filed: May 5, 2003

(51) Int. Cl. A23L 3/00

(52) U.S. Cl. 426/243

(57) ABSTRACT

A round paper towel made of the conventional fiber paper, flexible, absorbent and measuring 11 inches in diameter as shown in FIG. 1A. It can be used to cover food that has been put on a dinner plate measuring 10 inches in diameter as shown in FIG. 2A, prior to heating in a microwave oven not shown.

A smaller 8 inch in diameter paper towel of the same quality in FIG. 1 B can be used in the same manner for the 7 inch in diameter diner saucer in FIG. 2B.

This invention relates to Microwave Oven heating, specifically to foods. Sandwiches and other foods are heated in microwave ovens covered by square paper towels that were not designed for this purpose.

As the food turns while heating on the microwave oven turntable, the square corners catch inside and the towel spins off the food.

Accordingly, one advantage of my paper towel is that it has no corners to catch on the inside of the microwave oven. Thus, the round paper towel stays over the food allowing less splatter and more thorough heating. The square roll paper towels for clean ups are handled most times while cooking chicken and other food that could have bacteria and this same roll of paper towels, originally used for cleaning, is handled later by those who use them for microwave oven heating providing the opportunity to spread germs.

My round paper towels are more sanitary since they can be packaged in a box unattached to each other.

### REFERENCE NUMERALS IN DRAWING

FIG. 1A: Paper towel, eleven inches in diameter.

FIG. 2A: Dinner plate, ten inches in diameter.

FIG. 1B: Paper towel, eight inches in diameter.

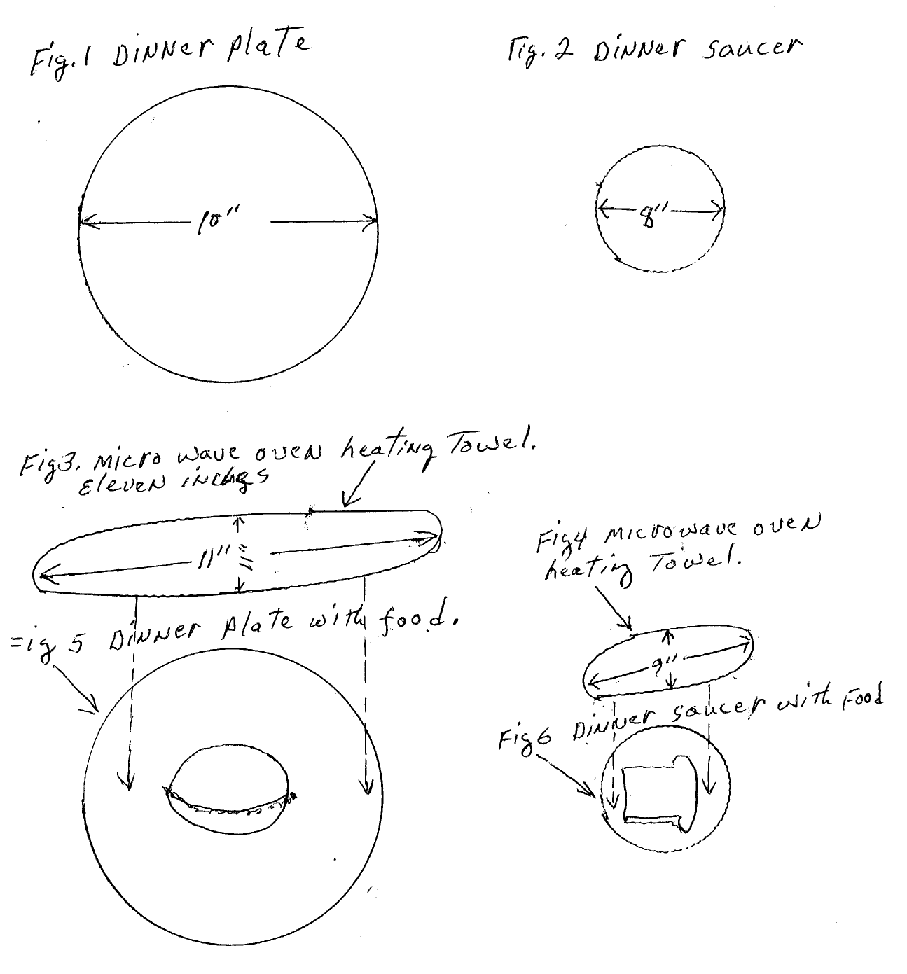

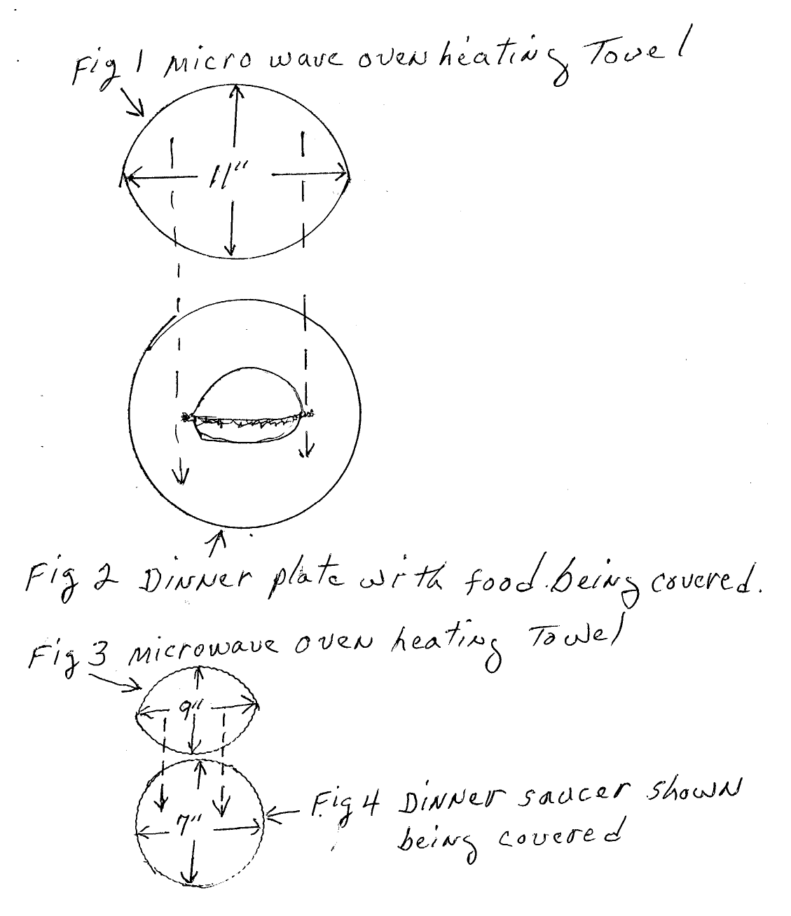

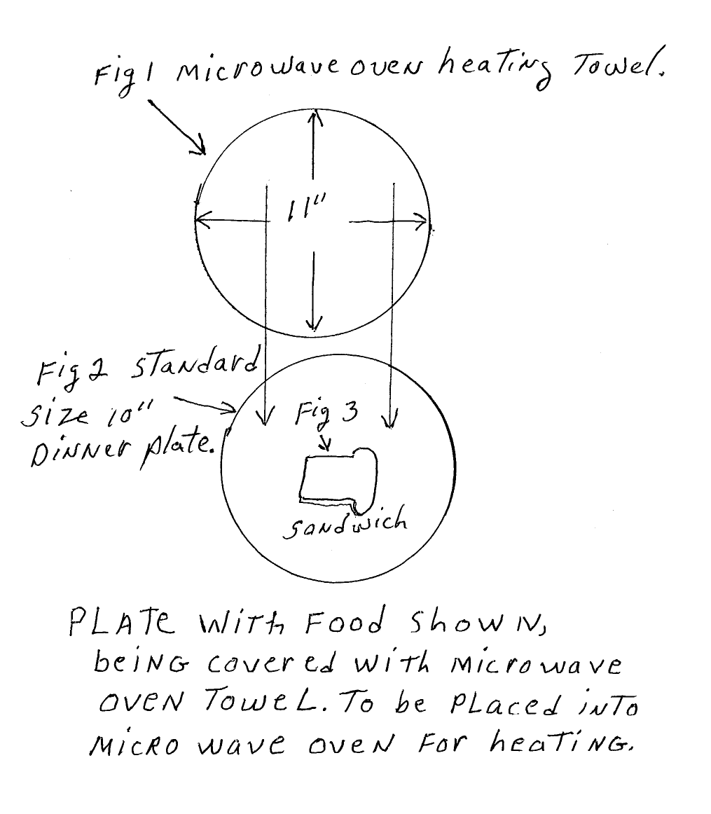

FIG. 2B: Dinner plate, seven inches in diameter.

What I claim as my invention:

1. A method of heating food covered by a paper towel in a microwave oven that will prove to be more sanitary, convenient and easier.
